(19) United States
(12) Patent Application Publication
(10) Pub. No.: US 2008/0261517 A1
(43) Pub. Date: Oct. 23, 2008

(54) Communication Framework and Method and System for Providing a Real-Time Audio and/or Video Signal

(76) Inventor: Yuan-Yuan Lin, Taipei City (TW)

Correspondence Address: THELEN REID BROWN RAYSMAN & STEINER LLP, P.O. BOX 640640, SAN JOSE, CA, 95164-0640, US

(21) Appl. No.: 12/048,224

(22) Filed: Mar. 14, 2008

(30) Foreign Application Priority Data
Apr. 18, 2007 (TW) 096113614

(51) Int. Cl. H04H 40/00

(52) U.S. Cl. 455/3.06

(57) ABSTRACT

A method for providing a remote real-time audio and/or video (AV) signal includes: displaying an AV terminal list that records a plurality of AV terminals, and requesting a user terminal to select one of the AV terminals in the AV terminal list; determining whether a connection has been established with the selected AV terminal; establishing the connection with the selected AV terminal, receiving the AV signal of the selected AV terminal, and forwarding the AV signal to the user terminal if it is determined that the connection has not been established; and making a duplicate of the AV signal of the selected AV terminal, and forwarding the duplicate AV signal to the user terminal if it is determined that the connection has been established. A communication framework that performs the method is also disclosed.

### CROSS-REFERENCE TO RELATED APPLICATION

This application claims priority of Taiwanese application no. 096113614, filed on Apr. 18, 2007.

### BACKGROUND OF THE INVENTION

1. Field of the Invention

This invention relates to a method for providing a remote real-time audio and/or video signal and to a communication framework that provides a remote real-time audio and/or video signal using the method.

2. Description of the Related Art

A conventional communication framework for providing a remote real-time audio and/or video (AV) signal includes a plurality of user terminals and an AV terminal. Each of the user terminals, such as a packet or a third generation (3G) compliant user terminal, is operable to access, i.e., establishes a connection with and receives an AV signal of, the AV terminal, such as an IP camera or a 3G-compliant camera, through a network, such as the Internet or a 3G telecommunication network.

The aforementioned conventional communication framework is disadvantageous in that the conventional communication framework merely permits a one-to-one connection between a user terminal and an AV terminal. As such, only one of the user terminals can access the AV terminal at a time.

### SUMMARY OF THE INVENTION

Therefore, the object of the present invention is to provide a communication framework and method and system for providing a remote real-time audio and/or video (AV) signal that permits multiple user terminals to simultaneously access an AV terminal.

According to an aspect of the present invention, a method for providing a remote real-time audio and/or video (AV) signal comprises:

A) when a login request is received from a user terminal, displaying an AV terminal list that records a plurality of AV terminals, each of which provides an AV signal of a surrounding environment, and requesting the user terminal to select one of the AV terminals in the AV terminal list;

B) determining whether a connection has been established with the selected AV terminal;

C) if it is determined that the connection has not been established with the selected AV terminal, establishing the connection with the selected AV terminal, receiving the AV signal of the selected AV terminal, and forwarding the AV signal to the user terminal; and

D) if it is determined that the connection has been established with the selected AV terminal, making a duplicate of the AV signal of the selected AV terminal, and forwarding the duplicate AV signal to the user terminal.

According to another aspect of the present invention, a communication framework comprises a plurality of AV terminals, an AV platform, and a user terminal. Each of the AV terminals generates a signal. The AV platform is connected to the AV terminals through a telecommunication network, and provides an AV terminal list, which records at least a portion of the AV terminals. The user terminal is connected to the AV platform through the telecommunication network, and is operable so as to receive the AV terminal list, and so as to generate an AV terminal-selecting signal, which includes a selected one of the AV terminals in the AV terminal list, and so as to send the AV terminal-selecting signal to the AV platform. The signal generated by the selected AV terminal is forwarded to the user terminal through the AV platform based on the AV terminal-selecting signal.

According to yet another aspect of the present invention, a system for providing a remote real-time AV signal to at least one user terminal comprises a plurality of AV terminals and an AV platform. Each of the AV terminals provides an AV signal of a surrounding environment. The AV platform is coupled to the AV terminals, is adapted to be coupled to the user terminal, and stores information pertinent to the AV terminals and the user terminal. When the AV platform receives a login request from the user terminal, the AV platform displays an AV terminal list that records corresponding ones of the AV terminals that correspond to the user terminal, requests the user terminal to select one of the AV terminals in the AV terminal list, and determines whether a connection has been established with the selected AV terminal. If it is determined that the connection has not been established with the selected AV terminal, the AV platform establishes the connection with the selected AV terminal, receives the AV signal of the selected AV terminal, and forwards the AV signal of the selected AV terminal to the user terminal. If it is determined that the connection has been established with the selected AV terminal, the AV platform makes a duplicate of the AV signal of the selected AV terminal, and forwards the duplicate AV signal to the user terminal.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic block diagram of the preferred embodiment of a communication framework for providing a remote real-time audio and/or video (AV) signal according to the present invention;

FIG. 2 is a schematic block diagram of an AV terminal of the preferred embodiment; and

FIGS. 3 to 6 are flowcharts to illustrate the preferred embodiment of a method for providing a remote real-time AV signal using a communication framework according to the present invention.

### DETAILED DESCRIPTION OF THE PREFERRED EMBODIMENT

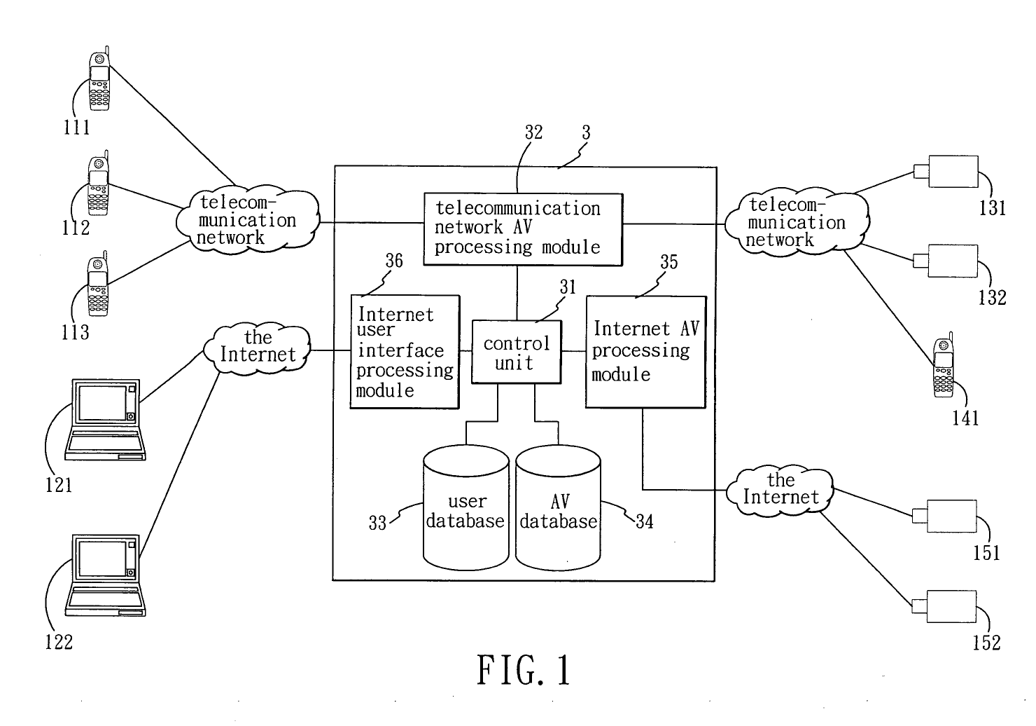

Referring to FIG. 1, the preferred embodiment of a communication framework for providing a remote real-time audio and/or video (AV) signal according to this invention is shown to include a system and a plurality of user terminals 111, 112, 113, 121, 122.

The system provides the user terminal 111, 112, 113, 121, 122 with an AV signal in real-time through a telecommunication network or the Internet, in a manner that will be described hereinafter.

In this embodiment, the telecommunication network is a third generation (3G) telecommunication network.

The system includes a plurality of AV terminals 131, 132, 141, 151, 152 and an AV platform 3.

Each AV terminal 131, 132 is a 3G-compliant camera, has an identification code, i.e., a phone number, and is connected to the telecommunication network.

The AV terminal 141 is a 3G-compliant mobile phone, has an identification code, i.e., a phone number, and is connected to the telecommunication network.

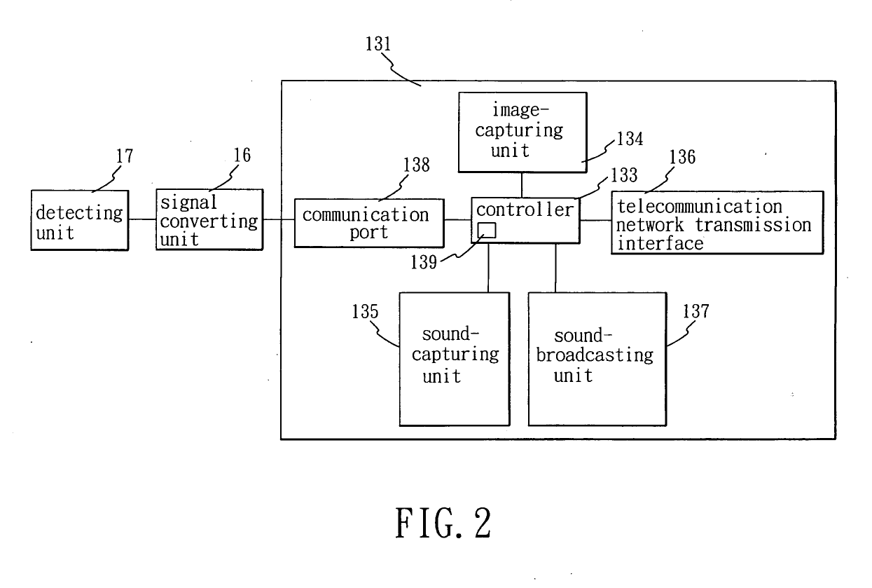

With further reference to FIG. 2, the AV terminal 131 includes a controller 133, an image-capturing unit 134, a sound-capturing unit 135, a telecommunication network transmission interface 136, and a sound-broadcasting unit 137.

The image-capturing unit 134 is connected to the controller 133, and is operable so as to capture images of a surrounding environment. The sound-capturing unit 135 is connected to the controller 133, and is operable so as to pick up sounds of the surrounding environment. The controller 133 combines the images captured by the image-capturing unit 134, i.e., a video signal, the sounds picked up by the sound-capturing unit 135, i.e., an audio signal, and/or a control signal into an AV signal. The telecommunication network transmission interface 136 is connected to the telecommunication network and the controller 133, and is operable so as to transmit the AV signal through the telecommunication network.

The AV terminal 131 is operable so as to issue an abnormal feedback-reporting request to the AV platform 3 through the telecommunication network. In particular, the AV terminal 131 further includes a detecting unit 17, a signal converting unit 16, and a communication port 138. The detecting unit 17 is operable so as to generate an actuating signal when activated, in a manner well known in the art. In this embodiment, the detecting unit 17 includes an anti-burglar detector, a smoke detector, or a motion detector. The signal converting unit 16 is connected to the detecting unit 17, and is operable so as to convert the actuating signal from an analog signal into a digital signal. The communication port 138, such as a universal serial bus (USB) port, is connected to the controller 133 and the signal converting unit 16, and is operable so as to receive the actuating signal. The controller 133, through an abnormal feedback-reporting program 139 installed therein, is further operable so as to generate the abnormal feedback-reporting request in response to the actuating signal from the communication port 138. The telecommunication network transmission interface 136 is further operable so as to transmit the abnormal feedback-reporting request through the telecommunication network.

It is noted that the AV terminal 131 may issue the abnormal feedback-reporting request to the AV platform 3 through the telecommunication network via an AV telephone call or a short message.

In an alternative embodiment, the AV terminal 141 generates the abnormal feedback-reporting request when a preset function key or a combination of keys thereof is pressed.

Each AV terminal 151, 152 is an IP camera, has an identification code, such as an Internet protocol (IP) address, and is connected to the Internet.

The AV terminal 151, 152, like the AV terminal 131, 132, 141, includes the controller 133, the image-capturing unit 134, the sound-capturing unit 135, the telecommunication network transmission interface 136, the sound-broadcasting unit 137, the detecting unit 17, the signal converting unit 16, and the communication port 138. The telecommunication network transmission interface 136 of the AV terminal 151, 152, however, is connected to the Internet, instead of the telecommunication network, and is operable so as to transmit the AV signal and the abnormal feedback-reporting request through the Internet.

In an alternative embodiment, the AV terminal 131, 132, 141, 151, 152 may be dispensed with one of the image-capturing unit 134 and the sound-capturing unit 135.

Referring once again to FIG. 1, the AV platform 3 is implemented as a computer server, and includes a control unit 31, a telecommunication network AV processing module 32, an Internet AV processing module 35, an Internet user interface processing module 36, a user database 33, and an AV database 34.

The control unit 31 controls operations of the AV platform 3, and is operable so as to establish connections with the user terminals 111, 112, 113 and the AV terminals 131, 132, 141 through the telecommunication network via the telecommunication network AV processing module 32.

The control unit 31 is further operable so as to establish a connection with the AV terminals 151, 152 through the Internet via the Internet AV processing module 35.

The control unit 31 is further operable so as to establish a connection with the user terminal 121, 122 through the Internet via the Internet user interface processing module 36.

The telecommunication network AV processing module 32 is connected to the telecommunication network and the control unit 31, and is operable so as to receive the AV signal and the abnormal feedback-reporting request of the AV terminal 131, 132, 141 through the telecommunication network, and so as to forward the AV signal and the abnormal feedback-reporting request of the AV terminal 131, 132, 141 to the user terminal 111, 112, 113 through the telecommunication network. The Internet user interface processing module 36 is connected to the Internet and the control unit 31, and is operable so as to forward the AV signal and the abnormal feedback-reporting request from the telecommunication network AV processing module 32 to the user terminal 121, 122 through the Internet. In this embodiment, the AV signal is first separated into the audio and video signals and/or the control signal by the telecommunication network AV processing module 32, and the audio and video signals and/or the control signal are then processed accordingly and are combined back into the AV signal by the control unit 31 prior to forwarding of the AV signal to the user terminal 111, 112, 113, 121, 122.

The Internet AV processing module 35 is connected to the Internet and the control unit 31, and is operable so as to receive the AV signal and the abnormal feedback-reporting request of the AV terminal 151, 152 through the Internet. The Internet user interface processing module 36 is further operable so as to transmit the AV signal and the abnormal feedback-reporting request from the Internet AV processing module 35 to the user terminal 121, 122 through the Internet. The telecommunication network AV processing module 32 is further operable so as to transmit the AV signal from the Internet AV processing module 35 to the user terminal 111, 112, 113 through the telecommunication network. In this embodiment, the AV signal is first separated into the audio and video signals and/or the control signal by the Internet AV processing module 35, and the audio and video signals and/or the control signal are then processed accordingly and are combined back into the AV signal by the control unit 31 prior to forwarding of the AV signal to the user terminal 111, 112, 113, 121, 122.

In this embodiment, the control unit 31 is further operable so as to make a duplicate of the AV signal of the AV terminal 131, 132, 141, 151, 152 being forwarded to the user terminal 111, 112, 113, 121, 122.

The user database 33 is connected to the control unit 31, and stores an identification code, i.e., a phone number, of the AV terminal 131, 132, 141, and an identification code, i.e., Internet protocol (IP) address, of the AV terminal 151, 152.

In this embodiment, the user database 33 further stores a first list, which includes at least one of the AV terminals 131, 132, 141, 151, 152, a second list, which includes at least one of the AV terminals 131, 132, 141, 151, 152, and a third list, which includes at least one of the user terminals 111, 112, 113, 121, 122.

In this embodiment, the first list includes the AV terminal 131, and is specific to the user terminal 111. That is, the AV terminal 131 in the first list is accessible by the user terminal 111, e.g., downloading of the AV signal of the AV terminal 131 by the user terminal 111 is permissible. Moreover, the second list includes the AV terminal 132, and is specific to the user terminal 112. That is, the AV terminal 132 in the second list is accessible by the user terminal 112. Further, the third list includes the user terminals 111, 112, and is specific to the AV terminal 131. That is, only the user terminals 111, 112 in the third list are able to access the AV terminal 131 when the AV terminal 131 issues the abnormal feedback-reporting request.

In addition, the user database 33 further stores a fourth list, which includes the AV terminal 151 that is accessible by the user terminal 111, 112, 113, 121, 122.

The AV database 34 is connected to the control unit 31, and stores a preset voiceover, e.g., narrations, specific to the AV terminal 131, 132, 141, 151, 152, and that is added to the AV signal of the AV terminal 131, 132, 141, 151, 152 being forwarded to the user terminal 111, 112, 113, 121, 122. In this embodiment, the AV database 34 is operable so as to store a backup of the AV signal of the AV terminals 131, 132, 141, 151, 152 being forwarded to the user terminals 111, 112, 113, 121, 122.

The user terminal 111, 112, 113 is a 3G mobile phone, has an identification code, i.e., a phone number, is connected to the telecommunication network, stores the identification code of the AV terminal 131, 132, 141, 151, 152, and is operable so as to receive the AV signal from the telecommunication network AV processing module 32 of the AV platform 3 through the telecommunication network and so as to transmit an AV signal, which includes audio and video signals and/or a control signal, through the telecommunication network.

The user terminal 121, 122 is a packet electronic device, such as a personal computer, has an identification code, i.e., an IP address, is connected to the Internet, stores the identification code of the AV terminal 131, 132, 141, 151, 152, and is operable so as to receive the AV signal from the Internet user interface processing module 36 of the AV platform 3 through the Internet and so as to transmit an AV signal, which includes audio and video signals and/or a control signal, through the Internet.

The telecommunication network AV processing module 32 of the AV platform 3 is further operable so as to receive the AV signal of the user terminal 111, 112, 113 through the telecommunication network and so as to forward the AV signal received thereby to a selected one of the AV terminals 131, 132, 141 through the telecommunication network. In this embodiment, the AV signal is first separated into the audio and video signals and/or the control signal by the telecommunication network AV processing module 32, and the audio and video signals and/or the control signal are then processed based on the identification code of the user terminal 111, 112, 113 and the control signal of the AV signal and are combined back into the AV signal by the control unit 31 prior to forwarding of the AV signal to the selected one of the AV terminals 131, 132, 141.

The Internet user interface processing module 36 is further operable so as to receive the AV signal of the user terminals 121, 122 through the Internet. The Internet AV processing module 35 is further operable so as to forward the AV signal from the Internet user interface processing module 36 to a selected one of the AV terminals 151, 152 through the Internet. In this embodiment, the AV signal is first separated into the audio and video signals and/or the control signal by the Internet user interface processing module 36, and the audio and video signals and/or the control signal are then processed based on the identification code of the user terminal 121, 122 and the control signal of the AV signal and are combined back into the AV signal by the control unit 31 prior to forwarding of the AV signal to the selected one of the AV terminals 151, 152.

The telecommunication network transmission interface 136 (see FIG. 2) of the AV terminal 131, 132, 141 is further operable so as to receive the AV signal from the telecommunication network AV processing module 32 through the telecommunication network. The sound-broadcasting unit 137 of the AV terminals 131, 132, 141 is operable so as to generate sounds corresponding to the audio signal of the AV signal from the telecommunication network transmission interface 136.

The telecommunication network transmission interface 136 (see FIG. 2) of the AV terminal 151, 152 is further operable so as to receive the AV signal from the Internet AV processing module 35 through the Internet. The sound-broadcasting unit 137 of the AV terminal 151, 152 is operable so as to generate sounds corresponding to the audio signal of the AV signal from the telecommunication network transmission interface 136.

It is noted that the identification code of the user terminal 111, 112, 113, 121, 122 may further include an account name and a password.

The user database 33 further stores the identification code of the user terminal 111, 112, 113, 121, 122.

The AV platform 3 has a plurality of identification codes, i.e., phone numbers and IP addresses.

The user terminal 111, 112, 113 and the AV terminal 131, 132, 141 further store one of the phone numbers of the AV platform 3.

The user terminal 121, 122 and the AV terminal 151, 152 further stores one of the IP addresses of the AV platform 3.

In this embodiment, each of the AV terminals 131, 132, 141 and the user terminals 111, 112, 113 communicates with the telecommunication network AV processing module 32 of the AV platform 3 over the telecommunication network through the 3G.324M protocol or the wireless application protocol/real-time streaming protocol (WAP/RTSP). Moreover, each of the AV terminals 151, 152 and the user terminals 121, 122 communicates with the Internet AV processing module 35 of the AV platform 3 over the Internet through the session initiation protocol/real-time transport protocol (SIP/RTP) or RTSP. Further, each of the telecommunication network AV processing module 32, the Internet AV processing module 35, and the Internet user interface module 36 communicates with the control unit 31 through the session initiation protocol/Internet protocol (SIP/IP).

In this embodiment, the user database 33 further stores a plurality of phone numbers, and maps the IP address of each of the AV terminals 151, 152 to a respective one of the phone numbers. As such, the user terminals 111, 112, 113, 121, 122 may simply store the phone numbers, instead of the IP addresses, of the AV terminals 151, 152.

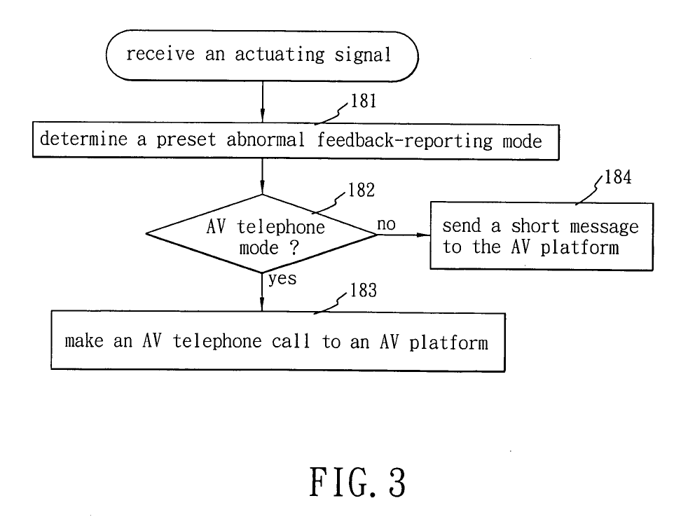

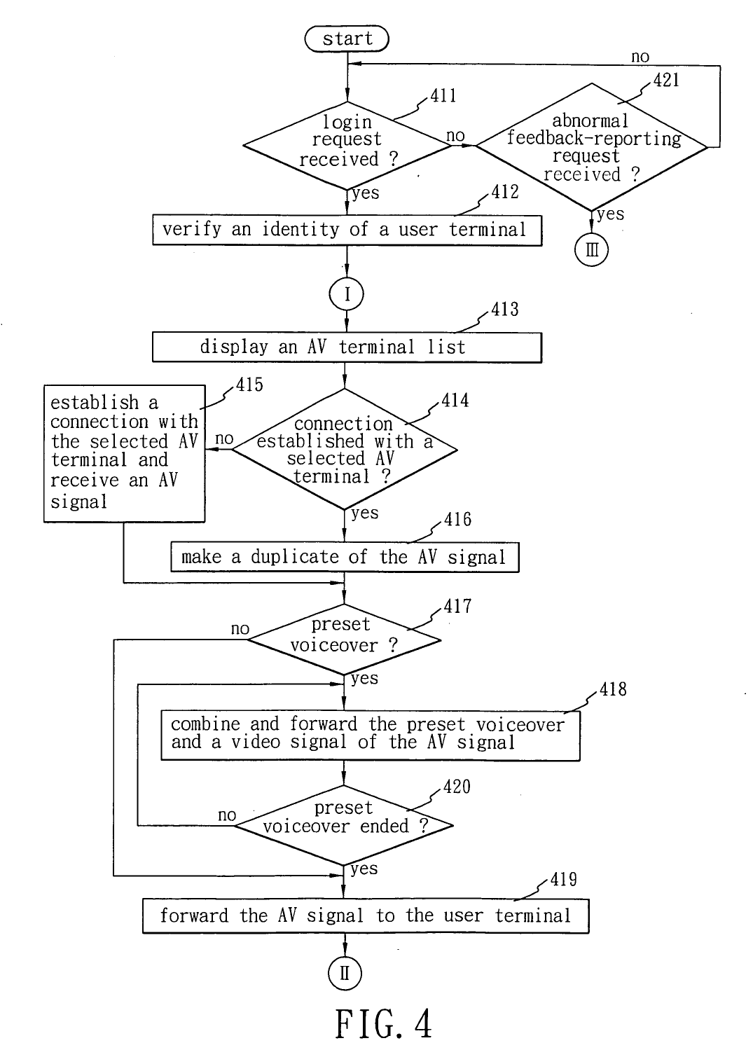

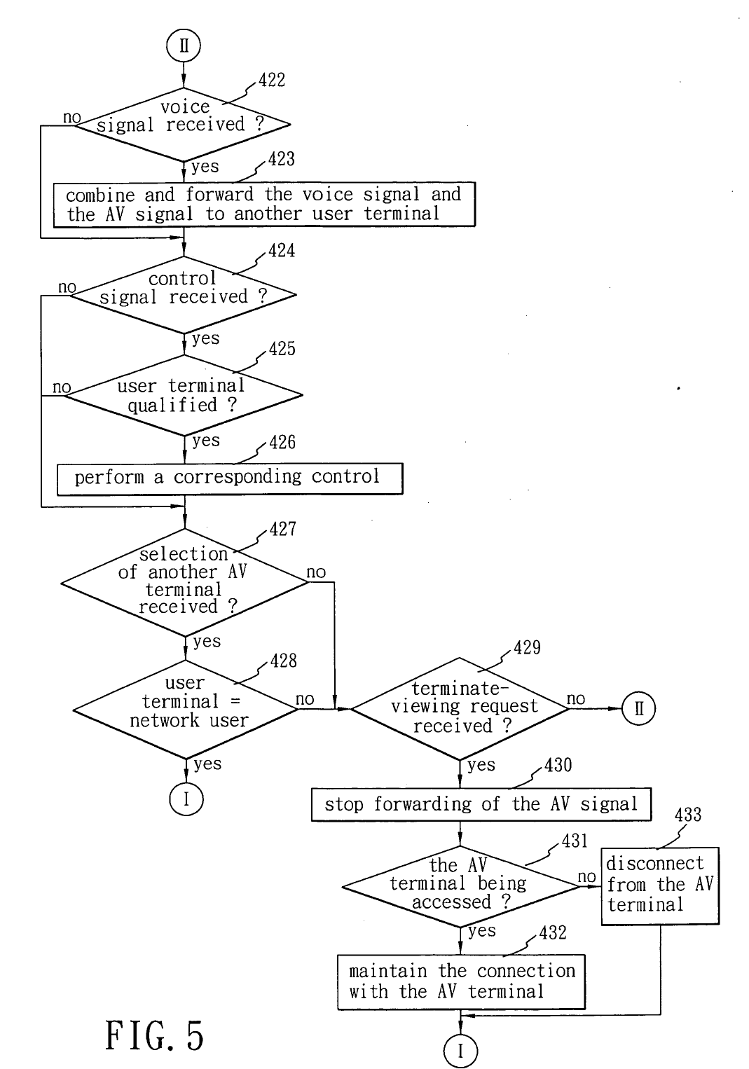

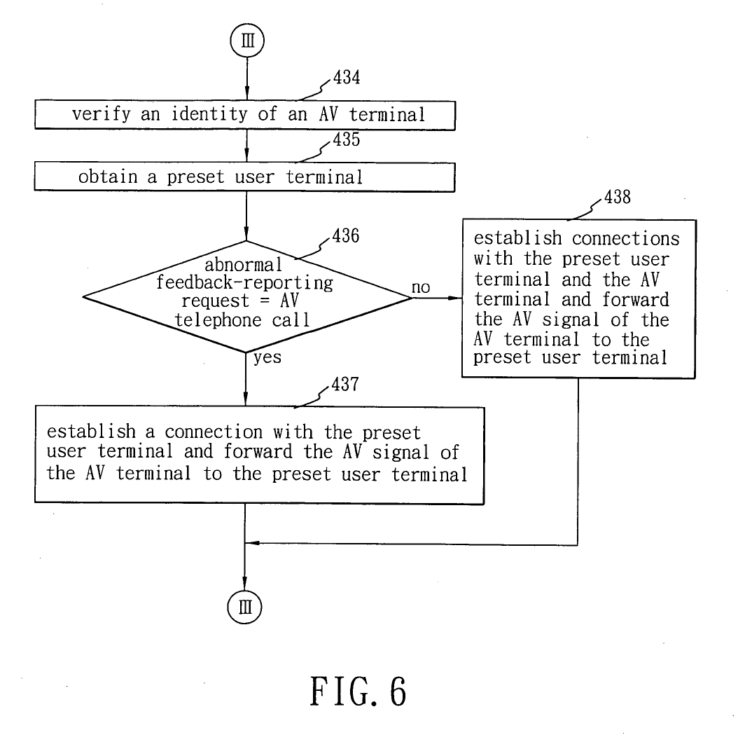

The preferred embodiment of a method for providing a remote real-time AV signal to be implemented using the aforementioned communication framework according to this invention will now be described with further reference to FIGS. 3 to 6.

When the AV terminal 131 receives an actuating signal, in step 181, a preset abnormal feedback-reporting mode, i.e., an AV telephone mode or a short message mode, is determined.

In step 182, if it is determined that the abnormal feedback-reporting mode is the AV telephone mode, the flow proceeds to step 183. Otherwise, the flow proceeds to step 184.

In step 183, the controller 133 makes an AV telephone call to the AV platform 3 through the AV terminal 131, processes a video signal captured by the image-capturing unit 134 and an audio signal captured by the sound-capturing unit 135 into an AV signal, and forwards the AV signal to the AV platform 3 through the telecommunication network, thereby permitting the AV platform 3 to forward the AV signal to a preset user terminal (in a manner that will be described hereinafter).

In step 184, the controller 133 generates and sends a short message to the AV platform 3, thereby permitting the AV platform 3 to execute subsequent processing (in a manner that will be described hereinafter). Hence, the AV terminal 131, upon occurrence of an abnormal condition, may notify the AV platform 3 through an AV telephone call or a short message to perform subsequent processing.

It is noted that the aforementioned abnormal feedback-reporting function may be integrated into the AV terminal 131, 132, as well as into the AV terminal 141. Moreover, the actuating signal, aside from the detecting unit 17, may also be generated by pressing one of function keys of the AV terminal 141 or by inputting a set of codes in the AV platform 3. Further, in response to the actuating signal, the AV terminal 141 issues an abnormal feedback-reporting request to the AV platform 3 through an AV telephone call or a short message.

In step 411, the AV platform 3 determines whether a login request is received. If it is determined that the login request is received, the flow proceeds to step 412. Otherwise, the flow proceeds to step 421.

In this step, when the login request is issued by the user terminal 111, 112, 113, the telecommunication network AV processing module 32 of the AV platform 3 receives the login request, converts the login request into a stream packet signal required by the control unit 31, and sends the stream packet signal to the control unit 31. On the other hand, when the login request is issued by the user terminal 121, 122, the Internet user interface processing module 36 of the AV platform 3 receives the login request, converts the login request into a steam packet signal required by the control unit 31, and sends the stream packet signal to the control unit 31.

In step 412, the control unit 31 compares the login request with the user information in the user database 33 to verify an identity of the user terminal, e.g., the user terminal 111, which issued the login request.

In step 413, the control unit 31 provides the user terminal with the AV terminal list, and the user terminal displays the AV terminal list and permits the user to make a selection.

The AV terminal list includes a plurality of AV terminals that are recorded in the user database 33 and that are accessible by the user terminal. For example, when the user terminal 111 is the administrator of the AV terminals 131 and the user terminals 112, 121 are group members of the user terminal 111, when the user terminal 112 is the administrator of the AV terminal 132, and the user terminals 111, 121 are set in the personal information of the user terminal 112 as group members, when the AV terminal 151 is a public AV terminal, when the user terminal 111 is not the administrator of the AV terminals 141, 152, and when the user terminal 111 not set as a group member by the administrator of the AV terminals 141, 152, the AV terminal list includes the AV terminals 131, 132, 151. When the user terminal 111 selects one of the AV terminals 131, 132, 151, the user terminal 111 generates an AV terminal-selecting signal, which contains the selected AV terminal, and forwards the AV terminal-selecting signal to the control unit 31 of the AV platform 3.

It should be apparent to those skilled in the art that the AV terminal list may include AV terminals that the AV platform 3 has established connections with.

When the user terminal 111 selects the AV terminal 131, in step 414, the control unit 31 determines whether the AV platform 3 has established a connection with the AV terminal 131. If it is determined that the AV platform 3 has not established the connection with the AV terminal 131, the flow proceeds to step 415. Otherwise, i.e., the AV platform 3 has established the connection with the AV terminal 131, the flow proceeds to step 416.

In step 415, the control unit 31 establishes the connection with the AV terminal 131 through the telecommunication network AV processing module 32, and commands the AV terminal 131 to forward the AV signal thereof to the AV platform 3.

In step 416, the control unit 31 makes a duplicate of the AV signal of the AV terminal 131 that is being forwarded to a user terminal, e.g., the user terminal 112.

In step 417, it is determined whether the AV terminal 131 has a preset voiceover. If it is determined that the AV terminal 131 has a preset voiceover, the flow proceeds to step 418. Otherwise, the flow proceeds to step 419.

In step 418, the control unit 31 obtains the preset voiceover and a video signal of the duplicate AV signal in the AV database 34, combines the preset voiceover and the video signal, and forwards the combined preset voiceover and video signal to the user terminal 111 through the telecommunication network AV processing module 32 after converting a format of the combined preset voiceover and video signal. Thereafter, the flow proceeds to step 420.

In step 419, the control unit 31 forwards the duplicate AV signal to the user terminal 111 through the telecommunication network AV processing module 32.

In this step, the user terminals, e.g., the user terminals 111, 112, 121, may carry on a conversation while accessing the AV terminal 131. That is, each of the user terminals 111, 112, 121 may send a voice signal, such as an audio signal or a voice of the user of the user terminal. Moreover, the user of the user terminal may set the AV terminal to mute and whether or not the voice signal is forwarded to the AV terminal from the setting information in the user information.

In step 420, the control unit 31 determines whether the preset voiceover has ended. If is determined that the preset voiceover has ended, the flow goes back to step 419. Otherwise, the flow goes back to step 418.

The control unit 31 processes an AV signal, such as by combining the AV signal with a voiceover or by converting a format of the AV signal, based on each of the user terminals 111, 112, 113, 121, 122. As such, the AV signal of the AV terminal may be forwarded to different user terminals 111, 112, 113, 121, 122.

The AV platform 3, which serves as a medium between the AV terminals 131, 132, 141, 151, 152 and the user terminals 111, 112, 113, 121, 122, separates the AV signal of each of the AV terminals 131, 132, 141, 151, 152 or a signal of each of the user terminals 111, 112, 113, 121, 122 into video, audio and control signals. Each of the video, audio and control signals is converted into a stream packet signal, and is forwarded to the control unit 31 for subsequent processing, such as identity verification, AV signal duplication, image capturing, AV mixing, and signal format conversion. As such, not only that the AV terminal 131 is accessible by the user terminals 111, 112, but the AV terminal 131 is accessible by the user terminal 121 through the telecommunication network and the Internet. For example, the control unit 31 forwards the AV signal of the AV terminal to the user terminal after the format of the AV signal of the AV terminal 131 is converted by the Internet user interface processing module 36. This permits different user terminals to access different formats of the AV signal of the AV terminal through the AV platform 3. Further, the control unit 31 may edit the AV signal of the AV terminal such that the video signal of the AV signal and a voiceover are combined into a new AV signal. The voiceover may describe relative information of the AV terminal 131, such as a background or a location.

In step 421, the control unit 31 determines whether an abnormal feedback-reporting request is received. If it is determined that the abnormal feedback-reporting request is received, the flow proceeds to step 434. Otherwise, the flow goes back to step 411.

In step 422, the control unit 31 determines whether a voice signal is received from the user terminals 111, 112, 121. If it is determined that the voice signal is received, the flow proceeds to step 423. Otherwise, the flow proceeds to step 424.

In step 423, the control unit 31, based on the setting information of the user, combines the voice signal and the AV signal of the AV terminal 131, and forwards the combined voice signal and AV signal to another user terminal that accesses the AV terminal 131. The control unit 31, based on the setting information, decides whether or not to forward the voice signal to the AV terminal for broadcasting. In particular, when the audio signal is generated by the user terminal 111, the control unit 31 determines a conversation mode from the user information of the user terminal 111 in the user database 33 whether the AV terminal 131 is set to mute or not and whether or not to forward a conversation to the AV terminal 131. When the AV terminal 131 in the conversation mode is set to mute and the conversation is set to be forwarded to the AV terminal 131, the control unit 31 combines the voice signal and the video signal of the AV signal of the AV terminal 131, forwards the combined voice and video signals to the user terminals 112, 121 that access the AV terminal 131, and forwards the voice signal to the AV terminal 131 for broadcasting. On the other hand, when the AV terminal 131 is not set to mute and the conversation is not set to be forwarded to the AV terminal 131, the control unit 31 combines the voice signal, the video signal of the AV signal of the AV terminal 131, and the audio signal, and forwards the combined voice, video and audio signals to the user terminals 112, 121 that access the AV terminal 131. As such, aside from the voice signal, the user terminals 112, 211 can also hear the audio signal of the AV terminal 131. Therefore, each of the user terminals 111, 112, 121 may generate a voice signal to carry on a conversation, thereby enhancing interaction between the user and the AV terminal.

In step 424, the control unit 31 determines whether a control signal is received from the user terminal 111. If it is determined that the control signal is received, the flow proceeds to step 425. Otherwise, the flow proceeds to step 427.

It is noted that the control signal permits the user terminals 111, 112, 113 to control the selected AV terminal through the AV platform 3. Moreover, the control signal is a digital signal, such as a dual-tone multi-frequency (DTMF) signal.

In step 425, the control unit 31 determines whether the user terminal 111 is qualified. This is to prevent unauthorized user terminals from controlling the AV terminal 131. If it is determined that the user terminal 111 is qualified, the flow proceeds to step 426. Otherwise, the control signal is ignored and the flow proceeds to step 427.

In this embodiment, the user terminal 111 is determined to be qualified by the control unit 31 when the user terminal 111 is the administrator of the AV terminal 131.

In step 426, the control unit 31 performs a control that corresponds to the control signal.

For example, when the control signal is a duplicating signal, the control unit 31, while forwarding the AV signal of the AV terminal 131 to the user terminal 111, makes and stores a duplicate of the AV signal into the AV database 34. It is noted that the duplicate AV signal stored in the AV database 34 is in a 3G partnership project (3GP) format defined by the third generation partnership project (3GPP). On the other hand, when the control signal is for controlling a function of the AV terminal 31, e.g., zoom in, zoom out, mute, receive audio, and lens adjustment, the control unit 31 forwards the control signal to the AV terminal 131 through the telecommunication network AV processing module 32. The AV terminal 131 then performs a control that corresponds to the control signal, e.g., adjusting focal distance or stopping from capturing sounds and images of the surrounding environment. As such, the user terminal 111, aside from receiving the AV signal of the AV terminal 131, may employ the AV platform 3 to process the AV signal, such as by making a duplicate of the AV signal, and to control the AV terminal 131.

Currently, electronic equipments, which can be connected to the Internet, are capable of opening several windows simultaneously. As such, in step 427, the control unit 31 determines whether selection of another AV terminal, e.g., the AV terminal 132, is received from the user terminal 121 that accesses the AV terminal 131. This indicates that the user terminal 121 wants to access the AV terminal 132. If it is determined that selection of the AV terminal 132 is received, the flow proceeds to step 428. Otherwise, the flow proceeds to step 429.

In step 428, the control unit 31 determines whether the user terminal 121 is a network user. A network user is a user that is connected to the Internet. If it is determined that the user terminal is a network user, the flow goes back to step 413 for providing the AV signal of the AV terminal 132 to the user terminal 121. Otherwise, selection of the AV terminal 132 is ignored and the flow proceeds to step 429.

In step 429, the control unit 31 determines whether a terminate-viewing request is received. For example, the user terminal 111, which accesses the AV terminal 131, issues the terminate-viewing request. If it is determined that the terminate-viewing request is received, the flow proceeds to step 430. Otherwise, the flow goes back to step 422 to wait for another control signal or request.

In step 430, the control unit 31 stops forwarding of the AV signal of the AV terminal, e.g., the AV terminal 131, to the user terminal, e.g. , the user terminal 111.

In step 431, the control unit 31 determines whether the AV terminal, e.g., the AV terminal 131, is being accessed by another user terminal. If it is determined that the AV terminal is being accessed, the flow proceeds to step 432. Otherwise, the flow proceeds to step 433.

In step 432, the AV platform 3 maintains the connection with the AV terminal 131, and continues to receive and forward the AV signal of the same to another user terminal.

In step 433, the control unit 31 disconnects from the AV terminal 131.

After steps 432 and 433, the flow goes back to step 413 so as to provide the user terminal 111, which issued the terminate-viewing request in step 429, with the AV terminal list, thereby permitting the user terminal 111 to select and access another AV terminal.

Step 433 includes the sub-step of permitting the user terminal 111 to issue a logout request to the AV platform 3, thereby disconnecting the connection therebetween.

In step 434, the control unit 31 verifies an identity of the AV terminal to identify a user of the AV terminal.

In step 435, the control unit 31 obtains a preset user terminal based on the user information in the user database 33. The preset user terminal is set by an administrator of the AV terminal, is stored in the user database 33, and can include one or more user terminals.

In step 436, it is determined whether the abnormal feedback-reporting request is an AV telephone call. If it is determined that the abnormal feedback-reporting request is an AV telephone call, the flow proceeds to step 437. Otherwise, i.e., the abnormal feedback-reporting request is a short message, the flow proceeds to step 438.

In step 437, the AV signal of the AV terminal and the abnormal feedback-reporting request are simultaneously forwarded to the AV platform 3 through the established connection between the AV terminal and the AV platform 3. The control unit 31 then establishes a connection with the preset user terminal, and forwards the AV signal to the preset user terminal. As such, the preset user terminal is immediately notified, and can be aware of an actual condition of the AV terminal through the video signal of the AV signal of the AV terminal. Thereafter, the flow goes back to step 422.

In step 438, the control unit 31 establishes connections with the preset user terminal and the AV terminal, which issued the abnormal feedback-reporting request, through the telecommunication network AV processing module 32, and forwards the video signal of the AV signal of the AV terminal to the preset user terminal. Thereafter, the flow goes back to step 422.

In steps 437 and 438, when there are two or more preset user terminals, the preset user terminals may perform steps 422 and 423 to carry on a conversation, and the voice signal may be forwarded to the AV terminal for broadcasting to warn an offender.

It is noted that the sequence of the aforementioned steps 411, 421, 422, 424, 427, and 429 may be altered as required.

From the above descriptions, in this invention, the AV platform 3, for security measures, verifies an identity of the user terminal before granting the user terminal access to the AV terminal. Moreover, the AV platform 3 separates the AV signal into the video, audio and control signals prior to processing of the AV signal. As such, the AV signal of the AV terminal may be provided to different user terminals. Further, the AV platform 3 permits the user terminals to carry on a conversation. In addition, the AV platform 3 makes a duplicate of an AV signal or controls the AV terminal upon receipt of a control signal issued by the user terminal, permits the network users to simultaneously access multiple AV terminals, and automatically forwards an AV signal of the AV terminal to the preset user terminal upon receipt of an abnormal feedback-reporting signal issued by the AV terminal.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A method for providing a remote real-time audio and/or video (AV) signal, said method comprising:
A) when a login request is received from a user terminal, displaying an AV terminal list that records a plurality of AV terminals, each of which provides an AV signal of a surrounding environment, and requesting the user terminal to select one of the AV terminals in the AV terminal list;
B) determining whether a connection has been established with the selected AV terminal;
C) if it is determined that the connection has not been established with the selected AV terminal, establishing the connection with the selected AV terminal, receiving the AV signal of the selected AV terminal, and forwarding the AV signal to the user terminal; and
D) if it is determined that the connection has been established with the selected AV terminal, making a duplicate of the AV signal of the selected AV terminal, and forwarding the duplicate AV signal to the user terminal.

2. The method as claimed in claim 1, wherein, in step A), when the login request is received from the user terminal, an identity of the user terminal is verified, and the AV terminal list is based on the identity of the user.

3. The method as claimed in claim 1, wherein the AV signal of the AV terminal includes a video signal, an audio signal, and a control signal, and, in steps C) and D), the AV signal is first separated into the audio signal, the video signal, and the control signal, and the audio, video, and control signals are converted into the same format.

4. The method as claimed in claim 3, wherein, in steps C) and D), it is determined whether the selected AV terminal has a preset voiceover prior to forwarding of the AV signal to the user terminal;
if it is determined that the selected AV terminal has a preset voiceover, the preset voiceover and the AV signal are combined and are forwarded to the user terminal; and
if it is determined that the selected AV terminal has no preset voiceover, the AV signal is forwarded to the user terminal.

5. The method as claimed in claim 3, further comprising:
E) when a voice signal is received from the user terminal, and when the AV signal of the selected AV terminal is being forwarded to another user terminal, combining the voice signal and the AV signal, and forwarding the combined voice and AV signals to said another user terminal.

6. The method as claimed in claim 5, wherein, in step E), the voice signal is further forwarded to the selected AV terminal.

7. The method as claimed in claim 1, further comprising:
F) when a control signal is received from the user terminal, determining whether the user terminal is qualified, and performing a control that corresponds to the control signal if it is determined that the user terminal is qualified.

8. The method as claimed in claim 7, wherein, in step F), when the control signal is a duplicating signal, and when the user terminal is qualified, the AV signal is stored while forwarding the AV signal to the user terminal.

9. The method as claimed in claim 7, wherein, in step F), when the control signal is for controlling a function of the selected AV terminal, and when the user terminal is qualified, the control signal is forwarded to the selected AV terminal.

10. The method as claimed in claim 3, further comprising:
G) when selection of another AV terminal in the AV terminal list is received from the user terminal, determining whether the user terminal is a network user, performing step B) if it is determined that the user terminal is a network user, and ignoring selection of said another AV terminal if it is determined that the user terminal is not a network user.

11. The method as claimed in claim 1, further comprising:
H) when a terminate-viewing request is received from the user terminal, stopping forwarding of the AV signal to the user terminal, determining whether the AV signal of the selected AV terminal needs to be forwarded to another user terminal, maintaining the connection with the selected AV terminal if it is determined that the AV signal of the selected AV terminal needs to be forwarded to said another user terminal, and disconnecting the connection with the selected AV terminal if it is determined that the AV signal of the selected AV terminal does not need to be forwarded to said another user terminal.

12. The method as claimed in claim 1, further comprising:
I) when an abnormal feedback-reporting request is received from one of the AV terminals in the AV terminal list, obtaining a corresponding preset user terminal, and forwarding the AV signal of said one of the AV terminals to the preset user terminal.

13. A communication framework, comprising:
a plurality of AV terminals, each of which generates a signal;
an AV platform connected to said AV terminals through a telecommunication network, and providing an AV terminal list, which records at least a portion of said AV terminals; and
a user terminal connected to said AV platform through the telecommunication network, and operable so as to receive the AV terminal list, and so as to generate an AV terminal-selecting signal, which includes a selected one of said AV terminals in the AV terminal list, and so as to send the AV terminal-selecting signal to said AV platform;
wherein the signal generated by said selected AV terminal is forwarded to said user terminal through said AV platform based on the AV terminal-selecting signal.

14. The communication framework as claimed in claim 13, wherein said AV platform includes a telecommunication network AV processing module that is coupled to said user terminal, and a control unit that is coupled to said telecommunication network AV processing module, and that receives and processes a signal provided by said telecommunication network AV processing module.

15. The communication framework as claimed in claim 13, wherein the signal generated by each of said AV terminals includes at least one of an audio signal and a video signal, and the signal forwarded to said user terminal is at least one of an AV signal and a control signal.

16. The communication framework as claimed in claim 14, wherein said AV platform includes an Internet AV processing module and an Internet user interface processing module that are coupled to said control unit.

17. The communication framework as claimed in claim 16, further comprising:
a plurality of AV terminals coupled to the Internet, said Internet AV processing module being coupled to said AV terminals through the Internet; and
a user terminal coupled to said Internet user interface processing module of said AV platform through the Internet.

18. The communication framework as claimed in claim 14, wherein said AV platform includes at least one of an AV database and a user database that are coupled to said control unit.

19. The communication framework as claimed in claim 13, wherein each of said AV terminals includes at least one of an image-capturing unit, a sound-capturing unit, and a sound-broadcasting unit.

20. The communication framework as claimed in claim 13, wherein the AV terminal list of said AV platform records at least one of said AV terminals that has established a connection with said AV platform and/or that permits the user terminal to receive the signal thereof.

21. A system for providing a remote real-time audio and/or video (AV) signal to at least one user terminal, said system comprising:
a plurality of AV terminals, each of which provides an AV signal of a surrounding environment; and
an AV platform coupled to said AV terminals, adapted to be coupled to the user terminal, and storing information pertinent to said AV terminals and the user terminal;
wherein, when said AV platform receives a login request from the user terminal, said AV platform displays an AV terminal list that records corresponding ones of the AV terminals that correspond to the user terminal, requests the user terminal to select one of said AV terminals in said AV terminal list, and determines whether a connection has been established with said selected AV terminal;
if it is determined that the connection has not been established with said selected AV terminal, said AV platform establishing the connection with said selected AV terminal, receiving the AV signal of said selected AV terminal, and forwarding the AV signal of said selected AV terminal to the user terminal; and
if it is determined that the connection has been established with said selected AV terminal, said AV platform making a duplicate of the AV signal of said selected AV terminal, and forwarding the duplicate AV signal to the user terminal.

22. The system as claimed in claim 21, wherein at least one of said AV terminals is one of a third generation (3G) camera and a 3G mobile phone, said AV platform including
a control unit that controls operations of said AV platform, and
a telecommunication network AV processing module that is coupled to a telecommunication network, that receives the AV signal from one of said 3G camera and said 3G mobile phone, that separates the AV signal into an audio signal and a video signal, and that forwards the audio signal and the video signal to said control unit.

23. The system as claimed in claim 22, wherein at least one of said AV terminals is a packet camera, said AV platform further including an Internet AV processing module that is coupled to the Internet, that receives the AV signal from said packet camera, that separates the AV signal into an audio signal and a video signal, and that forwards the audio signal and the video signal to said control unit.

24. The system as claimed in claim 22, wherein said AV platform includes an AV database, the user terminal, which receives the AV signal, is operable so as to issue a duplicating signal to said AV platform, and said control unit makes a duplicate of the AV signal forwarded to the user terminal and stores the duplicate AV signal when said control unit of said AV platform receives the duplicating signal.

25. The system as claimed in claim 21, wherein said AV platform includes a user database, which stores a preset user terminal of a respective one of said AV terminals, each of said AV terminals is operable so as to generate an abnormal feedback-reporting request that corresponds to an actuating signal and that is forwarded to said AV platform, and said AV platform forwards the AV signal of said AV terminal, which issued the abnormal feedback-reporting request, to the preset user terminal.
